(19) United States
(12) Patent Application Publication
(10) Pub. No.: US 2007/0040702 A1
(43) Pub. Date: Feb. 22, 2007

(54) Method for creating highly integrated satellite systems

(76) Inventors: Todd J. Mosher, Littleton, CO (US); Brent E. Stucker, River Heights, UT (US)

Correspondence Address: THORPE NORTH & WESTERN, LLP., 8180 SOUTH 700 EAST, SUITE 200, SANDY, UT, 84070, US

(21) Appl. No.: 11/417,004

(22) Filed: May 2, 2006

Related U.S. Application Data
(60) Provisional application No. 60/677,659, filed on May 2, 2005.

(51) Int. Cl. G08G 1/04

(52) U.S. Cl. 340/943

(57) ABSTRACT

A method for manufacturing or creating highly integrated satellite systems intended for use within or to construct one or more satellite variants. The integrated satellite systems comprise embedded or encapsulated components, circuitry, and/or networks. Although other methodologies may be employed, an ultrasonic consolidation process is adapted to fabricate integrated satellite systems having a material matrix wherein one or more satellite components and/or material trace elements may be encapsulated. A direct write process may be used simultaneously or in succession with the ultrasonic consolidation process to deposit material traces onto one or more surfaces of the satellite components, thereby providing functional mesoscopic devices or systems.

### RELATED APPLICATIONS

This application hereby claims the benefit of U.S. Provisional Patent Application Ser. No. 60/677,659, filed May 2, 2005, and entitled, “Method for Creating Highly Integrated Satellite Modules Within a Modular Satellite Platform Architecture,” which is incorporated by reference in its entirety herein.

### GOVERNMENT SUPPORT CLAUSE

This invention was made with support from the United States Government, and the United States Government may have certain rights in this invention pursuant to USDOD NATIONAL RECONNAISSANCE OFFICE, NRO000-04-C-0035.

### FIELD OF THE INVENTION

The present invention relates generally to spacecraft, namely satellites, and to the manufacture of satellites and integrated satellite systems or components. More particularly, the present invention relates to a method and system for applying advanced, digitally driven manufacturing methodologies or techniques, such as additive manufacturing or rapid prototyping technologies in the form of ultrasonic consolidation and direct write, to the manufacture and/or reconfiguration of satellites and integrated satellite systems or components.

### BACKGROUND OF THE INVENTION AND RELATED ART

Satellites, and particularly small satellites, are becoming increasingly important as vehicles for scientific investigation, communication, military operations, humanitarian coordination, and other purposes. However, current limitations in manufacturing technologies and methodologies and the relatively high cost of producing satellites have deterred many from exploiting the otherwise useful capabilities of satellites simply because it is not feasible to do so. In addition, these same deterrents have required satellite users to restrict the number of satellites purchased and to be highly selective in the missions undertaken, more so than what might otherwise be desired. As such, commercial and governmental customers are seeking to reduce the costs and time involved in manufacturing satellites, as well as to increase the performance of these satellites to ensure they keep pace with modem technologies and that they are amendable to new applications.

Currently most satellites are designed using a custom or “craft design” methodology, where each satellite is designed and built in accordance with the mission it will perform. The satellites built based on this methodology consist primarily of one-of-a-kind, computer numerical control machined housings and deck plates, assembled using clean-room technologies by highly skilled technicians on an extended time-line. Integration of electronics and associated harnessing is also performed manually, often in this same clean-room environment. Using this methodology, costs associated with the design and fabrication of such satellites and schedule times are significantly increased. In attempts to somewhat alleviate these problems, several spacecraft manufacturers have implemented a “standard bus.” However, this standard bus is only standard in its ability to repeatedly use some of the subsystem designs to meet mission requirements. Those portions that do not meet these requirements must still be custom designed and then built. These standard buses are also still assembled in the manual, clean-room environment using a similar process to the custom designed satellite. As such, providing a standard bus only has resulted in minimal cost and schedule reductions.

The foremost cause of high costs in satellite manufacture using the craft design methodology, beyond the complex electronics and scientific instruments, is the fabrication of the satellite subsystems. This is due largely in part to the fact that they are manually assembled, that their component parts are constructed using conventional custom machining techniques, and that extensive testing is required for each satellite produced as a result of their use of these custom subsystems.

Despite the recent advances in satellites, there still remains an identified need to create a more efficient, flexible, and economical satellite that can provide flexibility in accomplishing various mission types, and that can be successfully deployed by those with limited budgets.

### SUMMARY OF THE INVENTION

In light of the problems and deficiencies inherent in the prior art, the present invention seeks to overcome these by providing a method for creating and interfacing highly integrated satellite systems and electronics systems using advanced additive manufacturing methodologies or techniques, such as ultrasonic consolidation and direct write. The present invention method, by employing additive manufacturing technologies, provides the ability to fabricate advanced, highly robust integrated satellite systems containing encapsulated electronics, computational and processing components, wiring, heat pipes, fibers, sensors, antennas, and other satellite-related components within a dense material matrix, such as aluminum. The present invention method is preferably capable of being carried out in a single manufacturing chain or operation, wherein the integrated satellite systems are relatively low in cost, are easily produced and reconfigurable, and are capable of high performance operations.

Advanced manufacturing techniques, particularly the additive manufacturing techniques of ultrasonic consolidation and direct write technologies, are able to improve the cost and capabilities of satellite manufacture. The main advantages of additive manufacturing technologies for satellite and integrated satellite systems manufacture are that they eliminate tooling, allow greater geometric complexity, enable novel material combinations, allow for embedded components, respond easily to design changes, and reduce human-related errors in manufacturing.

In accordance with the inventive concept as embodied and broadly described herein, the present invention features a method for fabricating a highly integrated satellite system for use with a satellite, wherein the method utilizes, at least in part, a layered additive manufacturing process. The method comprises: (a) obtaining one or more satellite components to be encapsulated within a material matrix; (b) defining any connections to be made to the one or more satellite components; and (c) encapsulating the satellite components in the material matrix in a temperature controlled environment so as to substantially not affect any materials making up the material matrix, the material matrix and the satellite components being operatively configured to form an integrated satellite system.

The present invention also features a method for fabricating a highly integrated satellite system for use with a satellite using, at least in part, an additive manufacturing technique, the method comprising: (a) rendering a computer aided design integrated satellite system model; (b) providing a plurality of material layers having contact surfaces therebetween; (c) forming the integrated satellite system, as based on the integrated satellite system model, in accordance with an ultrasonic consolidation process by transmitting ultrasonic vibrations to one or more of the contact surfaces to cause the material layers to consolidate and bond directly to one another without melting the material layers in bulk; and (d) positioning one or more satellite components between the material layers for the purpose of embedding the satellite components within a material matrix formed during the ultrasonic consolidation process.

The present invention further features a method for fabricating an integrated satellite system for use within a satellite, the method comprising: (a) rendering a computer aided design integrated satellite system model; (b) initiating an ultrasonic consolidation process to create an integrated satellite system based on the computer aided design integrated satellite system model; (c) embedding one or more satellite components within the integrated satellite system during the ultrasonic consolidation process; and (d) initiating a direct write process to automatically write a material trace on one or more surfaces of the integrated satellite system, including internal surfaces, the material trace being based on corresponding indicia in the integrated satellite system model.

The present invention still further features a method for fabricating an integrated satellite system comprising: (a) providing a plurality of material layers having contact surfaces therebetween; (b) transmitting ultrasonic vibrations to one or more of the contact surfaces to cause the material layers to consolidate and bond directly to one another to form a material matrix without melting the material layers in bulk; and (c) configuring the material layers to form the integrated satellite system.

The present invention still further features a method for forming a mesoscopic device on an integrated satellite system, the method comprising: (a) fabricating an integrated satellite system having one or more satellite components supported therein; and (b) depositing a material trace directly to a surface of the integrated satellite system to provide a mesoscopic device, the material trace having a pre-determined arrangement configured to enable the mesoscopic device to perform a pre-determined function.

The present invention still further features an integrated satellite system comprising: (a) an integrated satellite system being formed of a material matrix, and operatively related to at least one other integrated satellite system to perform a pre-determined function; (b) a satellite component encapsulated within the material matrix of the integrated satellite system, the satellite component also being configured to perform a pre-determined function; and (d) a material trace deposited onto one or more surfaces of the integrated satellite system to provide a mesoscopic device configured to perform a pre-determined function.

The present invention further features the ability to form internal structures and devices that don't necessarily involve encapsulating a physically separate satellite component, but instead form a different kind of integrated satellite system or subsystem, such as heating or cooling channels, heat pipes, internal copper layers, etc., via an ultrasonic consolidation process and/or direct write process.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It'will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a general graphical rendition of the present invention process for manufacturing or fabricating an integrated satellite system using a combination of ultrasonic consolidation and direct write technologies, according to one exemplary embodiment;

FIG. 2 illustrates a detailed graphical representation of an ultrasonic consolidation process, according to one exemplary embodiment;

FIG. 3 illustrates another detailed graphical representation of an ultrasonic consolidation process, according to one exemplary embodiment;

FIG. 4-A illustrates a graphical representation of an ultrasonic consolidation process, wherein various sensors and optical fibers are situated between metal layers;

FIG. 4-B illustrates a detailed, cross-sectional view of a plurality of satellite components as embedded within a material matrix;

FIG. 4-C illustrates still a more detailed, cross-sectional view of two satellite components as embedded within a material matrix;

FIG. 4-D illustrates a detailed, cross-sectional view of a satellite component as embedded within an aluminum material matrix;

FIG. 5 illustrates a perspective view of an exemplary heat pipe geometry as integrally formed into a material matrix using an ultrasonic consolidation process;

FIG. 6-A illustrates a cut away perspective view of an exemplary satellite panel having an integrated satellite system formed therein using an ultrasonic consolidation process;

FIG. 6-B illustrates a cut away side view of the satellite panel of FIG. 6-A;

FIG. 7 illustrates a chart of metal materials suitable for use in an ultrasonic consolidation process to fabricate an integrated satellite system;

FIG. 8-A illustrates a graphical representation of a prior art integrated satellite system having various components supported thereon;

FIG. 8-B illustrates a graphical representation of an integrated satellite system, similar to the one shown in FIG. 6-A, fabricated using the present invention additive manufacturing methodology; and

FIG. 9 illustrates an organizational chart highlighting some of the benefits and capabilities of using an additive manufacturing methodology to construct or fabricate integrated satellite systems for use within a satellite.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Based on prior related methods, the present invention identifies and sets forth a methodology intended to advance the way satellites, and other similarly constructed structures are manufactured. As will be discussed, various advanced manufacturing techniques are used to create integrated satellite systems having integrated components that are partially or completely embedded.

In general, the present invention describes a method for manufacturing or creating highly integrated satellite systems, such as various satellite panels (e.g., communications panels) using, preferably, a combination of digitally driven manufacturing methodologies or additive manufacturing techniques, namely ultrasonic consolidation and direct write. More specifically, the present invention seeks to employ computer controlled additive ultrasonic consolidation of metals, and direct write material dispensing to rapidly fabricate multi-functional integrated satellite systems having encapsulated thermal and electrical distribution networks. This is preferably done with the intent of producing digitally-reconfigurable integrated satellite systems, namely integrated satellite systems, having advanced capabilities. It is noted that the use of additive manufacturing techniques does not necessarily preclude the use of subtractive manufacturing techniques, as such techniques may complement any additive manufacturing techniques.

In the description that follows below, the additive manufacturing techniques of ultrasonic consolidation and direct write are detailed to illustrate exemplary methods of producing integrated satellite systems having integrated components within a satellite variant. However, it is specifically noted herein that the present invention is not limited to these, either alone or in combination, in any way. It is fully contemplated herein that other manufacturing methodologies, either in existence at the present time, or that are being developed, or that have not yet been developed, may be utilized to produce an integrated satellite system having encapsulated components, as well as material traces deposited on surfaces thereof to form one or more mesoscopic devices or systems (referred to collectively as mesoscopic devices). Other types of manufacturing methodologies capable of fabricating such integrated satellite systems will be apparent, or may become apparent, to those skilled in the art.

Additive manufacturing comprises automated techniques for creating parts directly from computer-aided-design (CAD) or other digital data. Additive manufacturing systems utilize the approach of constructing complex structures in a programmed layer-by-layer sequence. Initially, CAD models of complex structures are taken and digitally sliced into thin layers. These layers are then built and stacked one upon another until the entire part has been formed.

Additive manufacturing has many general benefits over traditional, subtractive manufacturing. These include geometric, material and cost benefits. From a geometric standpoint, an additive approach enables structures that are not possible by conventional methods, including enclosed volumes, internal passageways, and encapsulated objects. With additive manufacturing techniques, there are few geometric limitations. The unique geometrical options available using additive manufacturing can be highly beneficial to the manufacture of satellites and integrated satellite systems due to the ability to integrate multiple features into a single satellite component or panel and the ability to embed structures and utilize created or formed internal passageways.

Additive manufacturing techniques have several cost advantages over traditional manufacturing techniques. For low-volumes, additive manufacturing techniques are less expensive than traditional techniques for fabricating parts due to the lack of tooling and human intervention necessary.

Integrating advanced, metal-based ultrasonic consolidation with direct write capabilities facilitates several various manufacturing efficiencies by providing the ability to create satellite structural features, including completely enclosed volumes and encapsulated devices, directly from a computer aided design (CAD) rendering, as well as to automatically write networks of conductive and insulator material traces on conformal surfaces, such as internal conformal surfaces or external conformal surfaces, or both. As a result, what currently takes several months to complete may be completed in only days by eliminating a significant portion of labor-intensive conventional machining and manual electrical integration processes. In addition, the present invention provides significant reductions in system size, production costs, labor and schedule, all while maintaining, and likely increasing, satellite capabilities.

Due to their complexity and size, satellites, and particularly small satellites, are well suited to incorporate into their construction recent advances in digitally driven manufacturing methodologies. The evolution from classical subtractive CNC approaches to additive manufacturing and direct write techniques enables the fabrication of devices and structures that are more reliable and cost effective than their prior related counterparts. Indeed, digital manufacturing techniques, at work within complex systems such as satellites, provide many advantages over prior related manufacturing methodologies, many of which advantages are set forth herein, such as dramatic capability expansion, cost and schedule reductions, and capability enhancements.

One exemplary application wherein the present invention methodology of employing digital manufacturing techniques to construct satellites and integrated satellite systems may be well suited is within a modular platform architecture, which is comparably similar to the types of platform architectures utilized in the automotive and other consumer goods industries. One particular exemplary modular platform architecture that is designed for the manufacture of small satellites and that may be well suited to incorporate the present invention methodology is described in copending U.S. application Ser. No. ______, filed, May 2, 2006, and entitled, “MODULAR PLATFORM ARCHITECTURE FOR SATELLITES” [Attorney Docket No. 24585.NP] for a modular satellite platform architecture],” which is incorporated by reference in its entirety herein. Within this modular approach, the various modules formed and used in the construction of one or more different satellite variants may benefit from being formed, at least in part, by one or more digital manufacturing techniques as described herein. It is believed that the effective application of additive manufacturing techniques to satellite fabrication will both complement and greatly enhance the applicability and versatility of the modular satellite platform architecture concept. For example, by automating the manufacture of satellite and/or integrated satellite systems through computer aided tools and by drastically reducing fabrication time, “bounded customization” can be quickly and cheaply implemented, which means that the platform architecture-built satellite may accommodate last-minute modifications, within certain bounds, to customize the performance of the satellite for a specific mission.

Of course, the application of the present invention methodology to the construction of modular satellites based on a platform architecture is intended to be only exemplary. One skilled in the art will recognize that such methodologies may be implemented in the construction of other satellites and integrated satellite systems that are not built based on a platform architecture. In addition, although integrated satellite systems are the intended application for purposes of description herein, it is contemplated that the present invention method may be applied to areas outside of the satellite manufacturing arena. Generally speaking, the present invention methods may be applied in the manufacture of any type of structures that include structural, thermal and computational elements within a mass and/or volume restricted environment. These include, among others, aircraft and missile avionics, mobile diagnostic equipment, robotics components, and various portable electronic devices. Even these though, are not intended to be limiting as others may be realized.

As mentioned, the present invention provides several significant advantages over prior related manufacturing methods. For instance, and perhaps foremost, the present invention methodology will result in significant cost and time savings for producing operational satellites. Indeed, a major cause of high costs in current satellite manufacture relates to the fabrication, assembly, and integration of satellite subsystems. Advanced digital or additive manufacturing techniques, coupled with one or more subtractive techniques where needed or desirable, can decrease costs by unitizing construction, eliminating fixturing and tooling, building in complex electronic components, and increasing manufacturing repeatability, as well as by other ways. Other advantages of implementing a digital or additive manufacturing methodology into the manufacture of integrated satellite systems include the ability to eliminate tooling, to allow greater geometric complexity, to enable novel material combinations, to allow for embedded components, to respond easily to design changes, and to reduce human-related errors in manufacturing.

Each of the above-recited advantages, and others, will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

Preliminarily, the term “complex structure,” as used herein, shall be understood to mean any type of structure, system, or device that includes structural, thermal and computational or electronic elements (i.e. sensors, computational devices or wiring) within a mass and/or volume restricted environment. An example of one type of complex structure is an integrated satellite system operable within one or more satellite variants.

The term “integrated satellite system,” or “integrated satellite system,” as used herein, shall be understood to mean a particular type of complex structure. In addition, the term “integrated satellite system,” or “integrated satellite system,” as used herein, shall be understood to mean any suitable type of satellite component, subsystem, panel, and/or module, operable within or used to construct and/or operate a satellite and/or variants thereof. Examples of integrated satellite systems include, but are not limited to satellite panels, such as communications panels, power management panels, processor panels, solar array gimbal panels, attitude control panels; satellite modules (which may comprise one or more of the above-identified panels), such as propulsion modules, thruster group modules, launch interface modules, frame modules, and payload interface modules.

An integrated satellite system may comprise any size and shape, which may or may not be pre-determined.

The term “satellite component,” as used herein, shall be understood to mean any type or device, system, structure, or combination of these configured to perform a specific function and that may be encapsulated within the integrated satellite system. Examples of satellite components include, but are not limited to, structural components, structural connectors, processing and other computer components, actuators, sensors, transmitters, wiring, heat pipes, and electrical or fluid lines.

Examples of satellite components include various types of fibers, such as structural fibers, optical fibers, shape memory fibers, wire meshes, etc. Depending upon the type, such fibers can be used to strengthen structures, sense temperature and strain, send and receive signals, actuate structures, etc.

Another example of satellite components may include embedded electronics. One particular example might include embedded electronics controlled by USB, as commonly known. Various exemplary electronics devices include, but are certainly not limited to, Linux processors, connectors, strain gauges, accelerometers, temperature sensors, vibration sensors, magnetic sensors, resistive heaters, etc. Embedded electronics may be used to provide embedded intelligence (e.g., a satellite panel would be able to identify itself and interact with other satellite panels based on the knowledge of itself, a satellite panel may be able to reconfigure itself automatically to interact with other satellite panels), to construct self-identifying and self-monitoring satellite panels, to provide rapid integration, to eliminate of external wiring harnesses, to perform various processing and/or computing functions, to minimize test setups, to provide reconfigurable harnessing (e.g., that is integrated into a satellite panel, and/or that can be used to relocate components using plug-and-play), etc.

A satellite component may also comprise integral or internal satellite components that are formed or built from the ultrasonic consolidation and/or direct write processes, such as heating or cooling channels, heat pipes, internal copper layers, internal cavities or voids, etc. A heating or cooling channel may be formed and built into the material matrix using the ultrasonic consolidation process, with boundaries defined by the material matrix.

The term “integrated satellite system model,” or “integrated satellite system model,” as used herein, shall be understood to mean a description of the integrated satellite system to be fabricated, which description provides the additive manufacturing techniques with the digital information needed for fabricating the integrated satellite system. In other words, the additive manufacturing techniques of ultrasonic consolidation and direct write are able to fabricate the integrated satellite system based on the integrated satellite system model. The description will typically be contained as digital data within a CAD program, a combination of CAD programs, and/or as digital data derived from a scanning process, examples of which include coordinate measuring machines, laser scanning systems, magnetic resonance imaging machines and other processes.

The term “material matrix,” as used herein, shall be understood to mean any one or a combination of materials configured or caused to partially or completely encapsulate or embed one or more integrated satellite systems, or to define the boundaries of an integral satellite component caused to be formed or built therein. The materials may be layered or material layers, or non-layered to provide a continuous body.

The term “material trace,” as used herein, shall be understood to mean any type of material deposited onto a surface of an integrated satellite system for a functional purpose using a direct write technique. Examples of material traces include, conductive, insulative, capacitive, or biological material traces. Exemplary structures or devices that may be constructed, at least in part, from a material trace using the direct write technique include, but are not limited to, conductors, resistors, capacitors, batteries, antennas, functional distribution circuitry, and other similar structures.

The term “mesoscopic,” as used herein, shall be understood to mean a feature size that is typically greater than 10 micrometers, but less than 10 millimeters, in thickness and width. For instance, for a conductive trace, it would be mesoscopic if the thickness and width were 50 μm, regardless of the length of the material trace (which might be a few centimeters or as long as a meter or more).

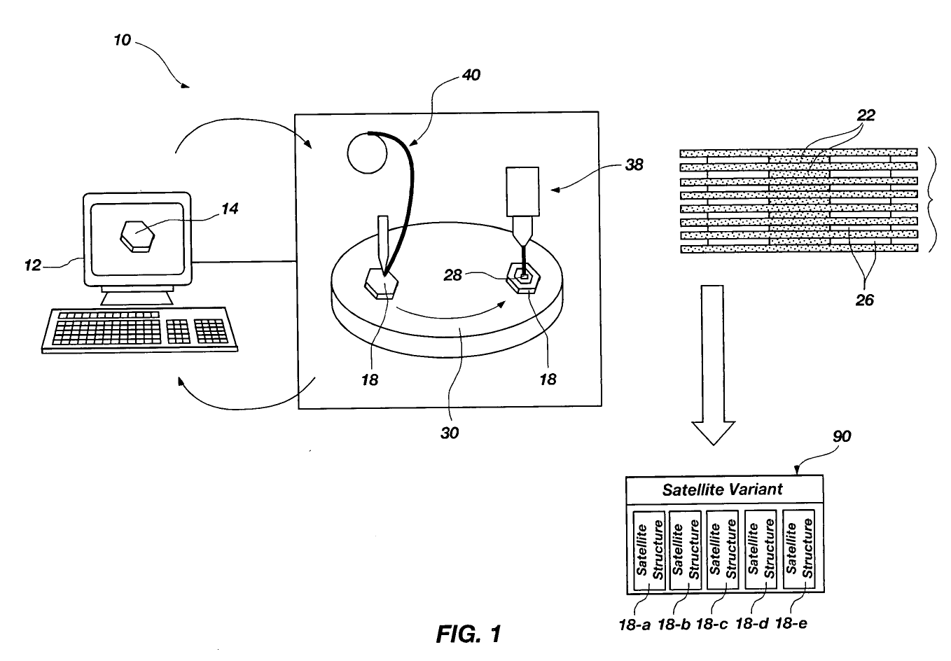

With reference to FIG. 1, illustrated is a general graphical rendition of the present invention process for manufacturing or fabricating an integrated satellite system using a combination of ultrasonic consolidation and direct write technologies, according to one exemplary embodiment. In the exemplary method shown, in which the method is represented generally as method 10, an integrated satellite system model 14 is generated on a computer 12 using any known and suitable CAD or other digital data/software program. In this case, the integrated satellite system model 14 comprises a modular hexagonal or honeycomb shaped satellite panel to be used in a satellite variant that is constructed based on a modular platform architecture. The CAD integrated satellite system model 14 is a digital representation of the integrated satellite system to be fabricated, and functions as a template for the digital manufacturing of the resulting integrated satellite system. By first constructing a CAD integrated satellite system model, designers and manufacturers are able to easily create, customize, and reconfigure the integrated satellite systems based on these models. In addition, because of the advantages provided by additive manufacturing techniques, when integrated satellite systems must be customized or reconfigured manufacturers may change the shape of an integrated satellite system simply using digital data changes. These changes may be reflected in a newly generated CAD model. In the case of a platform architecture approach, the platform design can be very easily digitally reconfigured to produce different satellite variants.

Another benefit of using a CAD system with additive manufacturing techniques is that any errors may be identified early on in the CAD model and corrected prior to manufacture of the actual integrated satellite system. This is a major advantage over conventional design methodologies, wherein a separate mock-up model of the various subsystems of the satellite is required for planning and design purposes, such as to achieve proper harness design and routing. These mock-up models require sufficient enough detail that the design may be transferred directly to the flight model without changes. Obviously, this requires significant cost and time to complete. Using the methods of the present invention, mock-up models may be eliminated in many, if not all cases.

FIG. 1 further illustrates an exemplary integrated satellite system, in the form of a satellite panel 18, being fabricated, which satellite panel 18 is based on the CAD integrated satellite system model 14 generated on the computer 12. The satellite panel 18 is comprised of multiple aluminum foil layers bonded together on an aluminum plate substrate. As can be seen, the geometry and structure of the satellite panel 18 is initially fabricated using an ultrasonic consolidation machine 40 within an ultrasonic consolidation process. The satellite panel 18 is supported during the ultrasonic consolidation process, as well as the direct write process, about a support surface 30, which may be a heat plate/anvil. A base plate 34 may also be present. The ultrasonic consolidation machine 40 may further function to embed one or more elements or components within the satellite panel 18 in accordance with the satellite design.

Once the integrated satellite system is formed, or intermittently during formation, it may be subjected to a direct write process, wherein a direct write machine, shown generally as direct write machine 38, functions to accurately and automatically apply small amounts of material to the integrated satellite system, in this case the satellite panel 18, to form circuitry or other useful mesoscopic devices or systems thereon. As is well known, the direct write machine 38 is capable of writing operational networks of conductive, insulator, and other material traces on internal conformal or other surfaces of the integrated satellite system. As an example, FIG. 1 illustrates the satellite panel 18 as comprising circuitry 28 disposed on its internal conformal surface.

FIG. 1 further illustrates a portion 18-a of the satellite panel 18, wherein depicted is the multiple aluminum foil layers 22 used to make up the physical structure of the satellite panel 18. Also depicted is several satellite elements or components 26 embedded or encapsulated within the structural layers of the satellite panel 18. As discussed herein, these embedded elements 26 may comprise structural reinforcements, fiber optics, heat pipes, trace elements, actuators, sensors, and a myriad of other components usable by or used to make up a satellite and its subsystems.

Upon formation, the integrated satellite system, or satellite panel 18, may be incorporated into and utilized to form a satellite, or more particularly a variant of a satellite, shown graphically in FIG. 1 as satellite variant 90. The integrated satellite system 18 may be combined with other integrated satellite systems, shown as integrated satellite systems 18-a, 18-b, 18-c, 18-d, and 18-e, that may or may not have also been fabricated using the ultrasonic consolidation and/or direct write technologies, to comprise the satellite variant 90. This will be particularly true in the case of a satellite constructed from a modular platform architecture, wherein one or more of the several modules fitted together to form the satellite may be fabricated using the present invention methodology.

The present invention seeks to utilize recent advances in additive manufacturing techniques to directly fabricate integrated satellite systems for use in satellites, whether these satellite are constructed based on a modular platform architecture approach or on a more conventional approach, and whether they may be classified as small satellites or large satellites. As shown generally in FIG. 1, by combining ultrasonic consolidation and direct write technologies, highly integrated satellite systems may be created. These techniques are discussed at greater length below.

### Ultrasonic Consolidation Implementation

The present invention method for forming integrated satellite systems, such as modular integrated satellite systems, contemplates and features, at least in some exemplary embodiments, the utilization of a rapid prototyping process, namely an additive manufacturing process, known as ultrasonic consolidation. Ultrasonic consolidation may be used alone or in conjunction with direct write, as discussed below, as far as the current invention is concerned. With recent advances in ultrasonic consolidation technology, fully functional metal structures can be formed at ambient or near room temperatures under highly localized plastic flow, thus making possible the embedding and encapsulation of critical components without worrying about elevated temperature affects on those components. For example, the elevated temperatures inherent in conventional metal-based additive manufacturing processes that utilize molten metal during processing function to damage or destroy most critical components of interest for embedding, such as circuitry, sensors, and/or actuators.

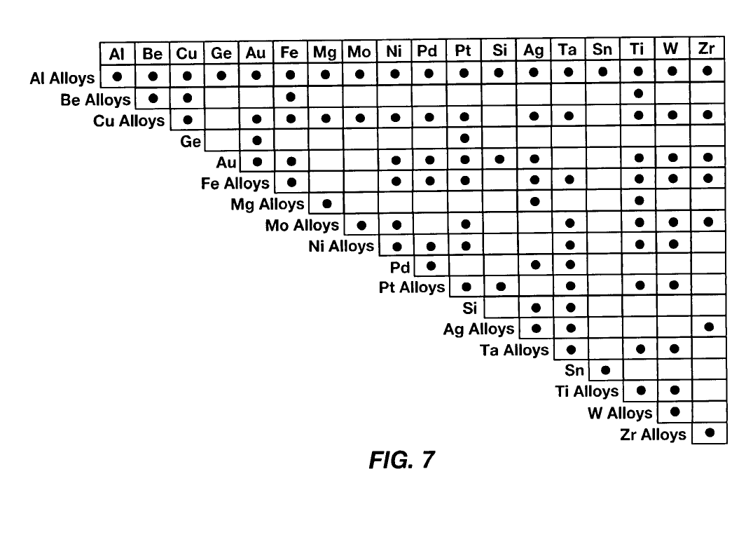

Ultrasonic consolidation provides the ability to form complex, three-dimensional structures from metals, plastics, ceramics, and combinations thereof. The compositions of these materials may vary discontinuously or gradually from one layer to the next. Plastic or metal matrix composite materials incorporating reinforcement materials of various compositions and geometries may also be used. In particular, and of particular interest to the present invention method of manufacturing integrated satellite systems, metal foils may be used, such as aluminum foils. However, the present invention contemplates the use of many different types of metal materials, and alloys of these, whether foil or not, such as aluminum, titanium, steel, silver, copper, and others (see FIG. 7).

Ultrasonic consolidation also provides the ability to embed various structures and/or components, such as electrical and circuitry components, sensor and transmitting components, actuation components, and others within the materials. Furthermore, ultrasonic consolidation provides the ability to actually build a satellite component within the material matrix, or in other words, configure the material matrix to define the boundaries of a satellite component. These “internal” or “integral” satellite components may be built during the ultrasonic consolidation process used to construct the integrated satellite system. Depending upon its type, various direct processes may or may not be required to finish or complete the satellite component. One particular example of an internal satellite component built using the ultrasonic consolidation process is structural channels or voids capable of providing a conduit or reservoir for fluid.

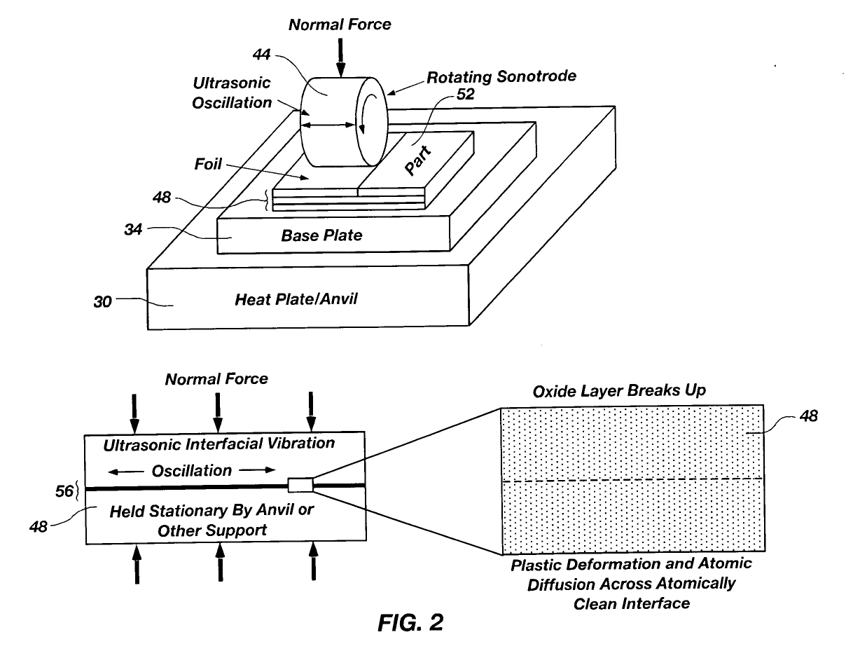

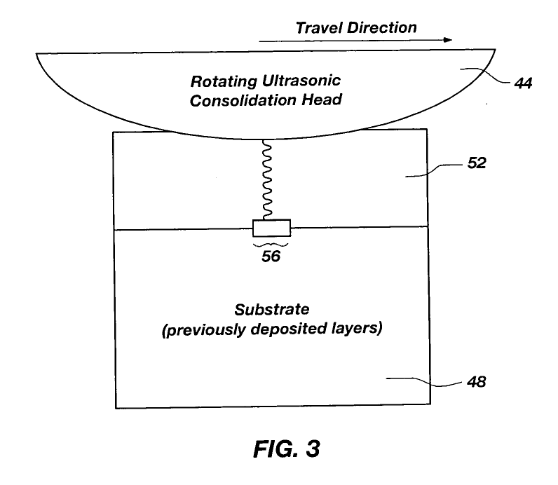

Generally speaking, and with reference to FIGS. 2 and 3, during one exemplary ultrasonic consolidation process, an excitation source, shown as a rotating ultrasonic consolidation head in the form of a sonotrode 44, is utilized to create interfacial vibration at a boundary or contact surface between two materials, namely a substrate layer 48 (a previously deposited material layer or layers) and a deposition layer 52 (that layer currently being added). Friction at the interface causes local plastic deformation within a deformation zone 56, which breaks up surface oxides, resulting in atomic diffusion and plastic flow, and a true metallurgical bond between the deposition layer and the substrate layer. The affected material thickness t is typically on the order of micrometers, generally between 50 and 500 μm thick. Moreover, the temperature rise between the materials is below the melting point of the materials, and the rise in overall bulk material temperature is minimal, typically being only a few degrees Celsius, thus being substantially below the melting point of the materials. Advantageously, throughout the process the mechanical properties of the parent material are for the most part preserved.

In addition to its other advantages, ultrasonic consolidation makes possible highly localized plastic flow for the purpose of embedding various integrated satellite systems or components. This is due to the fact that ultrasonic excitation has the same effect on enhancing plasticity that elevated temperatures has with respect to prior art conventional metal-based rapid prototyping processes or elevated temperature welding and bonding processes. Many different types of satellite components may be embedded within an integrated satellite system as a result of the manufacture of the integrated satellite system using an ultrasonic consolidation process.

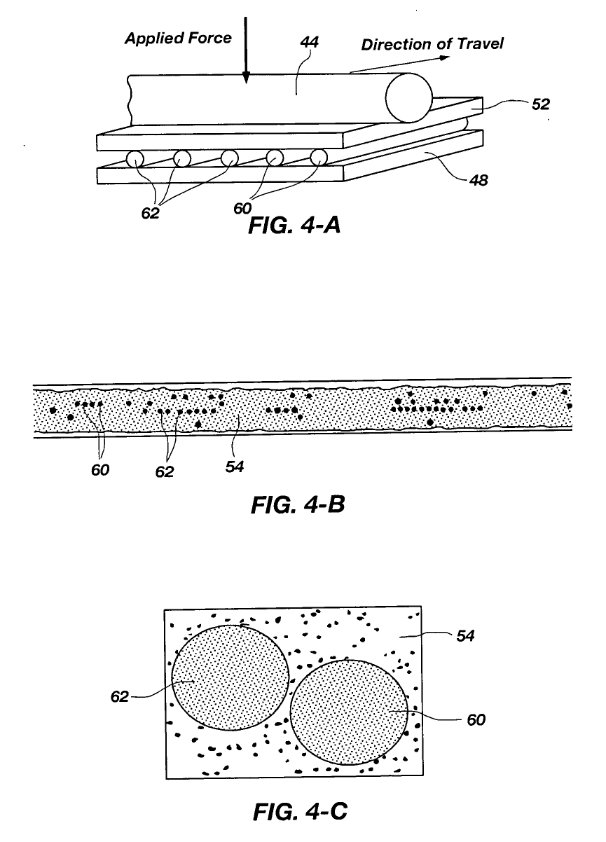

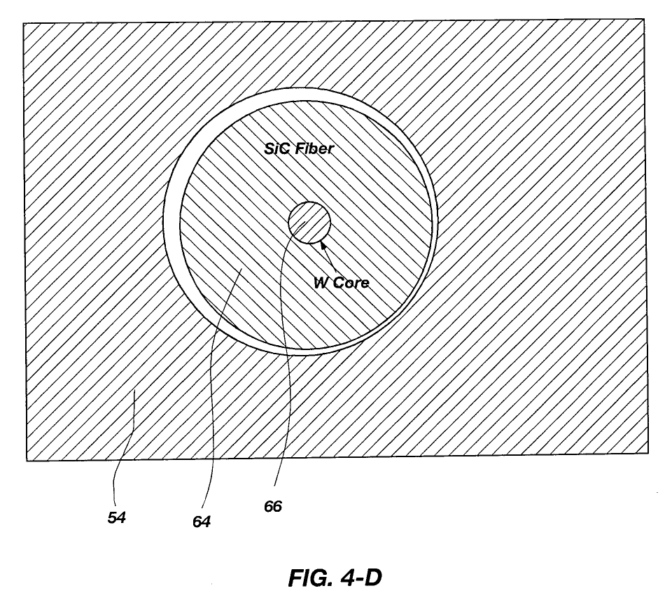

With reference to FIGS. 4-A-4-D, illustrated is one exemplary application of an ultrasonic consolidation process used to embed or encapsulate a plurality of satellite components, such as sensors, structural members and fibers, shape memory and/or optical fibers, wire meshes between aluminum foil layers to be contained within an aluminum matrix. As shown, an ultrasonically activated roller 44, functioning as the excitation source, is configured to create interfacial vibration at the boundary between a first, substrate aluminum foil layer 48 and a deposition aluminum foil layer 52. Situated and appropriately positioned between the aluminum foil layers 48 and 52 are a plurality of satellite components in the form of sensors 60 and/or various fibers, such as optical fibers 62, to be embedded therein. The fibers and other embedded satellite components, depending upon their makeup, can be used to strengthen structures, sense temperature and strain, send signals, actuate structures, etc. Upon completion of the process, the aluminum foil layers 48 and 52 form a material matrix 54.

FIG. 4-D illustrates a detailed, cross-sectional view of another exemplary satellite component in the form of an SiC fiber 64, having a W core 66, as embedded within an aluminum material matrix 54.

During the ultrasonic consolidation process, aluminum is caused to flow around the sensors and or various fibers, respectively, thus creating an aluminum matrix 54. It is noted that even in the event the optical fiber or sensor cross-sectional diameter exceeds the thickness of the individual aluminum layers, the aluminum material is still able to flow around these to create an aluminum matrix, thus encapsulating each of the individual sensors and optical fibers therein. Any excess material is then removed to produce the integrated satellite system.

As one skilled in the art will recognize, the ultrasonic consolidation technique provides the ability to embed other satellite components within an aluminum or other type of metal matrix to form an integrated satellite system, not just the sensors and or various fibers used as an example herein. An example of other types of satellite components that may be embedded within an integrated satellite system include, but are not limited to, different types of structural fibers to provide localized stiffening; various sensor and/or communications components to provide communication and sensing capabilities; actuators and/or shape memory fibers to effectuate actuation; wire meshes for planar or area stiffening purposes; computational devices; thermal management devices; heat pipes; electrical connectors; radiation shielding materials; and a myriad of other satellite components as known by those skilled in the art. For embedding of components which are significantly larger than the aluminum layer thickness, a cavity is machined in the aluminum matrix using an integrated CNC milling machine. The component is inserted in the cavity, and encapsulation of the component occurs due to ultrasonic consolidation of additional aluminum layers. Under certain circumstances it may be necessary to add a support material, such as an epoxy, into the machined cavity in order to support the addition of subsequent aluminum layer. This is commonly known as potting. In such cases, the method may further comprise forming a cavity or pocket, inserting the satellite component into the cavity, bonding the satellite component to the aluminum structure using thermal glue or any other known bonding agent, potting the satellite component in a support material, and covering the potted satellite component with aluminum. A support material, such as epoxy, however, may not always be required to pot a satellite component, particularly if the satellite component is small.

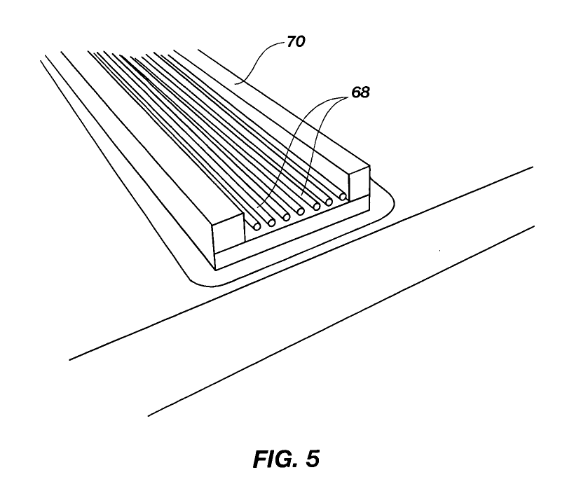

With reference to FIG. 5, illustrated is an exemplary heat pipe geometry. As shown, the heat pipe geometry comprises a series of heat pipes or channels 68 integrally formed within a material matrix 70 using an ultrasonic consolidation process, wherein the material matrix 70 may be configured in any structural geometric configuration. The heat pipes 68 may be used as part of an integrated thermal control or management system for one or more purposes, such as to facilitate fluid transfer for thermal dissipation.

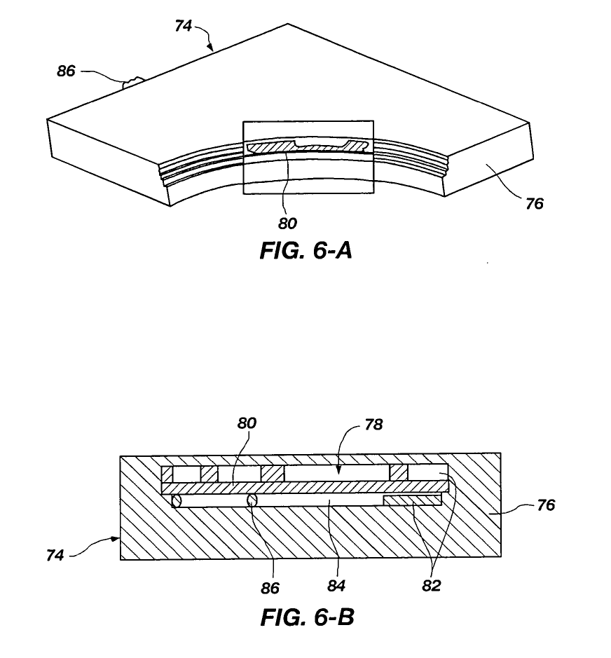

FIGS. 6-A and 6-B illustrate cut away perspective and side views, respectively, of an exemplary satellite panel having a satellite system formed therein in accordance with the present invention. As shown, the satellite panel 74 is comprised of a material matrix 76 having a cavity 78 formed therein. Contained within the cavity 78 is a sensor 80 that is potted within the cavity 78 using a potting epoxy 82. A second thermal epoxy 84 is also present for insulating purposes. The sensor 80 is electrically coupled to or comprises a digital output 86 extending from the satellite panel 74 and material matrix 76.

Although the ultrasonic consolidation process is not described in detail herein, and although not intended to be limiting in any way, the present invention method for constructing integrated satellite systems preferably employs the ultrasonic consolidation processes and methodologies as described at length in U.S. Pat. No. 6,519,500, issued on Feb. 11, 2003 to White; U.S. Pat. No. 6,463,349, issued on Oct. 8, 2002 to White; and U.S. Pat. No. 6,457,629, issued on Oct. 1, 2002 to White, each of the teachings of which are incorporated by reference in their entirety herein.

In some exemplary embodiments, complex integrated satellite systems are formed using an ultrasonic consolidation machine comprising a fully integrated machine tool, which incorporates an ultrasonic consolidation head, a three-axis milling machine, and software to automatically generate tool paths for material deposition and machining. The present invention method also contemplates some exemplary embodiments that utilize both additive and subtractive heads in the same machine to provide for the simple insertion of components into machined cavities prior to encapsulation by subsequent material addition, as well as the depositing of multiple materials at different layers and locations. These embedded component and multi-material capabilities enable the insertion and embedding of satellite relevant components directly into the integrated satellite system. Moreover, the fact that this can be accomplished on a computer-controlled machine tool means that the process of component integration can be done more quickly, accurately, and in higher component densities than is possible using prior related conventional satellite manufacturing methodologies. In addition, the use of a computer-controlled machine tool does not preclude the use of manual component insertion methods or material changes to achieve the same results.

FIG. 7 illustrates a chart of potential metal materials that may be used in the ultrasonic consolidation process to produce one or more integrated satellite systems. See O'Brien, R. L., Welding Processes, Welding Handbook, Vol. 2, 8th Edition, American Welding Society, Miami, 783-812, 1991. The graph illustrates the usability of many metal materials and alloys, where an ultrasonically weldable combination of materials is identified by a darkened circle. The particular material selected will largely depend upon the needed or desired characteristics of the integrated satellite system, keeping in mind that the integrated satellite system is to be used in the construction of a satellite designed for use in the harsh environment of space. This list of materials and alloys is not meant to be exhaustive in any way. Indeed, as ultrasonic consolidation techniques improve, other materials may be included for use.

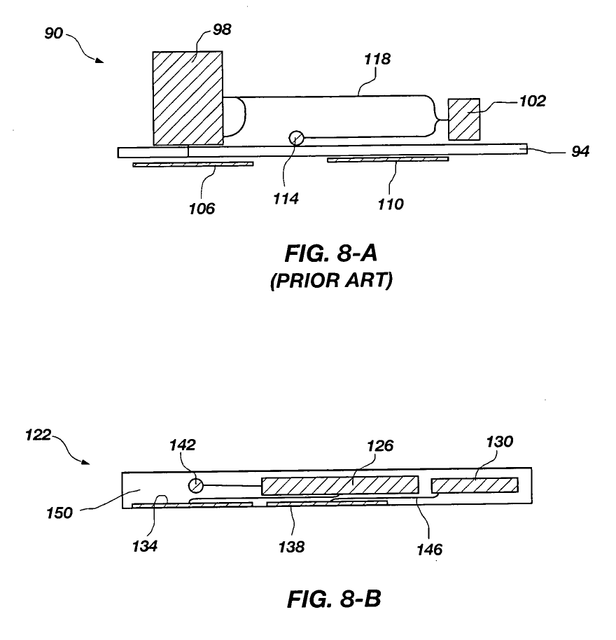

Referring now to FIG. 8-A, illustrated is one example of a prior art satellite or system formed using conventional manufacturing methodologies. The satellite system 90 comprises a support 94 configured to support first and second electronic units 98 and 102, first and second antennas 106 and 110, and sensor 104. Each of these various components are operably wired via wiring 118 in order to provide functionality to the satellite system 90. As can be seen, the configuration of the satellite system 90 is rather bulky, with many of the components being exposed.

Contrast the satellite system shown in FIG. 8-A with the one shown in FIG. 8-B. FIG. 8-B illustrates a similarly configured satellite system as that illustrated in FIG. 8-A, with the difference being that the satellite system shown in FIG. 8-B is fabricated using the present invention additive manufacturing methodology, wherein each of the components making up the satellite system are encapsulated within a matrix material, thus integrating these components. As such, the satellite system may be considered an integrated satellite system as discussed herein. The integrated satellite system 122 comprises first and second electronic units 126 and 130, first and second antennas 134 and 138, and sensor 142. In addition, each of these components is suitably and operably wired using wiring 146. Rather than comprising a pre-formed support, the integrated satellite system 122 comprises a matrix material 150 that encapsulates each of the above-identified components as a result of the integrated satellite system being fabricated, at least in part, from an ultrasonic consolidation process. The integrated satellite system 122 of FIG. 8-B has many advantages over the prior related satellite system 90 of FIG. 8-A, namely it comprises a more compact configuration, it has higher stiffness characteristics, it is isothermal, and it allows a satellite to comprise more volume for payload.

It is noted that those skilled in the art will recognize that the method of manufacturing integrated satellite systems may utilize other additive manufacturing techniques other than those described herein or in the above-identified patents, and that the present invention is not limited to these.

### Direct Write Implementation

The present invention method for forming integrated satellite systems, such as modular integrated satellite systems, contemplates and features, at least in some exemplary embodiments, the utilization of the additive manufacturing process known as direct write. Direct write technologies may be utilized alone or in combination with ultrasonic consolidation technologies to introduce a high degree of automation in the manufacture of satellites and integrated satellite systems, wherein the operational capabilities of these satellites are greatly enhanced, as well as such satellites and integrated satellite systems being cheaper to construct.

Direct write additive manufacturing technologies, as known in the art, utilize a dispensing or depositing head or nozzle to accurately and automatically apply small amounts of material to form circuitry or other useful mesoscopic devices or systems. In operation, the direct write apparatus or machine is capable of applying conductive, insulator, or biological material traces (e.g., as small as twenty microns in width) on virtually any curved or irregular surface, thus providing a pre-determined function. In some exemplary embodiments, surface contours of the integrated satellite system are laser scanned and the data subsequently stored for path planning of the dispensing nozzle. For example, the CAD data comprising the integrated satellite system to be manufactured may comprise information and instructions for the direct write process. In other words, the material traces deposited on the integrated satellite system may be based on corresponding indicia as contained and defined in the CAD model.

Using direct write, insulated electrical distribution or data networks may be directly written within the internal contours or other surfaces of a metallic satellite structural member as that structure is being built, with high accuracy and throughput, and with continuity. Direct write also makes possible robust connections to electrical device terminals without soldering, although soldering may be utilized to further strengthen the connection. As applicable to the present invention, direct write technologies provide the ability to form conductors, capacitors, batteries, antennas, functional distribution circuitry, and other similar structures or devices on or within an integrated satellite system, such as a satellite panel, as the structure is being manufactured.

Moreover, and although not required, integration of direct write with ultrasonic consolidation provides the ability to yield a multi-functional integrated satellite system with encapsulated direct write networks and other systems, something not found in prior related satellites and their satellite systems or subsystems. Combining ultrasonic consolidation with direct write technologies, either simultaneously or in succession, provides the ability to produce advanced satellite platforms with increased or enhanced functional capabilities. For example, as batteries, antennas and processors are able to be embedded within or fabricated on a single integrated satellite system, the present invention contemplates that several traditional integrated satellite systems or components may be integrated into a single module, thus reducing the size of the overall satellite design or enabling the integration of additional payloads. In addition, due to the inherent reconfigurability of additive manufacturing, these integrated satellite systems can be modified easily.

As stated above, the ability to reconfigure and modify the integrated satellite systems lends itself particularly well to the platform architecture approach identified above. In essence, being able to reconfigure and modify integrated satellite systems, such as the various modules to be assembled in the formation of a satellite variant, enables the manufacture of several design variants, which variants are desirable for an effective platform architecture implementation. To be responsive and affordable, integrated satellite systems fabricated based on a platform architecture approach may possess a modular, “plug and play” architecture, leveraging commercial off-the-shelf parts and standards, while preserving satellite variant customization. The present invention methodology facilitates “bounded customization,” whereby encapsulated devices and features, or direct write network layouts within a standard platform structure can be modified quickly and easily, although within certain bounds, before or during a build sequence by altering parameters in the input CAD or other digital data files. This will allow platform variants to be efficiently and cost-effectively implemented.

As indicated, the present invention contemplates utilizing one or more existing direct write methodologies. An example of one or more direct write methodologies, and various implementations thereof, that may be employed is described in a book by Alberto Pique and Douglas B Chrisey, published in 2002, in San Diego, by Academic Press, entitled, “Direct-write technologies for rapid prototyping applications: sensors, electronics, and integrated power sources,” which is incorporated by reference herein. One skilled in the art will recognize that other similar direct methodologies not described or incorporated herein may be used.

The advanced additive manufacturing technologies described above provide significant value to the manufacture of integrated satellite systems in many ways, particularly as applied to the manufacture of satellites and integrated satellite systems based on a platform architecture. First, the additive manufacturing methodologies reduce integrated satellite system manufacturing cost and cycle time by automating many wiring, assembly, integration and machining operations. Second, they increase the capabilities of satellite platforms by allowing greater functionality without an increase in mass or volume. Third, they reduce launch costs by realizing more efficient use of volume and thus lower mass as compared to traditional satellites. Fourth, they provide greater flexibility in engineering critical structural properties, such as stiffness and resonant modes.

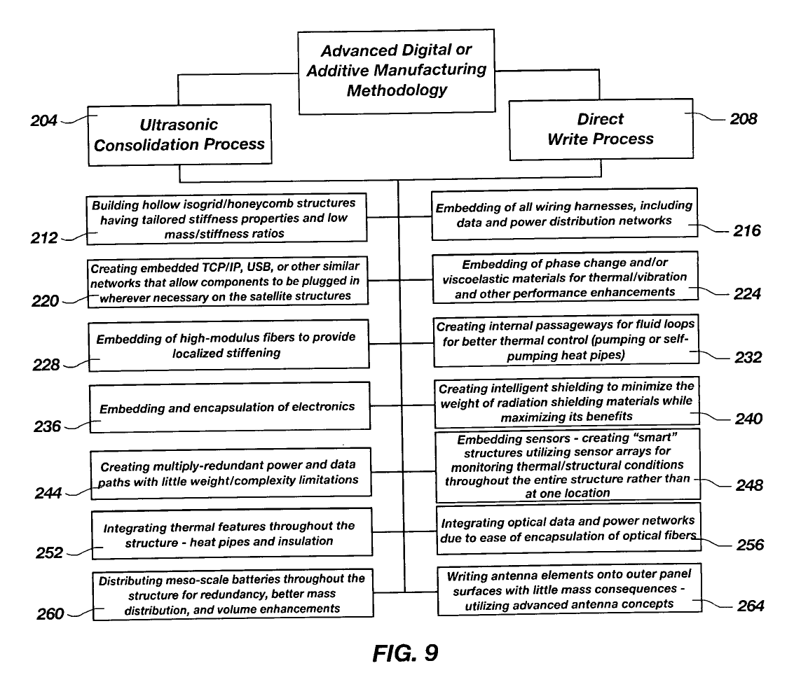

FIG. 9 illustrates an organization chart highlighting some of the specific satellite improvements which can be realized with an appropriate combination of ultrasonic consolidation 204 and direct write 208 technologies. The items specifically identified in FIG. 9 include, but are not limited to—212, building hollow aluminum isogrid/honeycomb structures that have tailored stiffness properties and lower mass/stiffness ratios than machined aluminum; 216, embedding of all wiring harnesses, including data and power distribution networks; 220, creating embedded TCP/IP or USB networks that allow components to be plugged in wherever necessary on the platform panels; 224, embedding of phase change and/or viscoelastic materials for thermal/vibration and other performance enhancements; 228, embedding of high-modulus fibers to provide localized stiffening; 232, creating internal passageways for fluid loops for better thermal control (either pumping the fluid or designing self-pumping heat pipes); 236, embedding and encapsulating electronics; 240, creating intelligent shielding strategies to minimize the weight of radiation shielding materials while maximizing their benefits (e.g. embedded tantalum sheets around embedded electronics); 244, creating multiple, redundant power and data paths with little weight/complexity drawbacks due to the ease of the direct write techniques; 248, embedding sensors to reduce the likelihood of damage to the sensor, to minimize sensor attachment weight, and to create “smart” structures which utilize sensor arrays for monitoring thermal/structural conditions throughout the structure rather than at just one location; 252, integrating thermal features throughout the structure, such as heat pipes where necessary and insulation where needed; 256, integrating optical data and power networks due to ease of encapsulation of optical fibers; 260, distributing meso-scale batteries throughout the structure for redundancy, better mass distribution, and volume enhancements; and 264, writing of antenna elements onto outer panel surfaces, including solar panels, with little mass consequences, thus eliminating the need for deployable antennas, allowing for multiple-redundancy antennas that will transmit/receive regardless of the orientation of the satellite, and utilizing advanced antenna concepts, including fractal antennas, software-tunable radios, phase arrays, and others due to the ease of direct write writing.

The following examples are illustrative of the present invention methods. These examples are not meant to be limiting in any way, and should not be construed as such.

### EXAMPLE ONE

As some specific examples, the present invention contemplates creating highly integrated satellite systems for use on one or more satellite variants. One foreseeable integrated satellite system may comprise a smart, self-sensing, self-identifying, and self-adjusting satellite panel. One particular type of panel may comprise embedded USB networks with integrated computer processors, such as LINUX processors. Another type of satellite panel may comprise a sandwich structure to mimic the properties of a composite honeycomb panel.

Foreseeable integrated satellite systems may be those having advanced heat pipe geometries, embedded copper for thermal dissipation, and pumped cooling loops for thermal control. Indeed, it is contemplated that thermal control can be completely embedded within the satellite structure or variant. To achieve embedded thermal control, the satellite variant may comprise embedded heat pipes and devices, heaters, coolers, temperature sensors, thermal switches, high conductivity materials, conductive and insulating materials, phase change materials, and others. Moreover, the present invention provides rapid thermal reconfiguration of various satellite structures as the embedded thermal systems provide specific thermal control that is both flexible and customizable.

Finally, each satellite system developed and designed and constructed, along with its several materials, components, etc. integrated, can be stored and maintained in an electronic database for later use. In addition, a geometric constraint rule library can be built and updated. Each of these will assist in the design and construction of future satellite systems.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not expressly recited, except in the specification. Accordingly, the scope of the invention should be determined solely by the appended claims and their legal equivalents, rather than by the descriptions and examples given above.

What is claimed and desired to be secured by Letters Patent is:

1. A method for fabricating a highly integrated satellite system using, at least in part,: a layered additive manufacturing process, wherein said satellite system is configured for use with a satellite, said method comprising:
obtaining one or more satellite components to be encapsulated within a material matrix;
defining any connections to be made to said one or more satellite components; and
encapsulating said one or more satellite components in said material matrix in a temperature controlled environment so as to substantially not detrimentally affect any materials making up said satellite component, said material matrix and said satellite components being operatively configured to form an integrated satellite system.

2. The method of claim 1, further comprising creating an integrated satellite system model from digital data, in which said integrated satellite system is based upon said integrated satellite system model facilitating said fabrication of said integrated satellite system.

3. The method of claim 1, wherein said defining any connections comprises defining connections selected from the group consisting of electrical connections, mechanical connections, thermal connections, fluid connections, and any combination of these, between said integrated satellite systems and any separate components and structures.

4. The method of claim 3, further comprising interconnecting at least one of said satellite components of said integrated satellite system to at least one other satellite component of said integrated satellite system using one of said connections.

5. The method of claim 3, further comprising connecting at least one of said satellite components of said integrated satellite system to at least one other satellite component contained within a separate integrated satellite system.

6. The method of claim 3, further comprising connecting at least one of said satellite components of said integrated satellite system to a separate component or structure not part of said integrated satellite system.

7. The method of claim 1, further comprising operatively interfacing said satellite component with at least one other satellite component to form at least part of said satellite.

8. The method of claim 1, wherein said encapsulating comprises:
positioning one or more satellite components for the purpose of preparing said satellite components to be encapsulated within said material matrix; and
initiating an ultrasonic consolidation process to effectuate said encapsulating of said satellite components, as well as said forming of said integrated satellite system.

9. The method of claim 8, wherein said initiating comprises transmitting ultrasonic vibrations to one or more contact surfaces of various positioned material layers to define said material matrix, said ultrasonic consolidation process causing said material layers to consolidate and bond directly to one another without melting said material layers in bulk.

10. The method of claim 1, further comprising initiating a direct write process, wherein one or more material traces is automatically written on one or more surfaces of said integrated satellite system to provide said integrated satellite system with a pre-determined function.

11. The method of claim 10, wherein said material traces are based on corresponding indicia in an integrated satellite system model of said integrated satellite system.

12. The method of claim 1, further comprising reconfiguring said integrated satellite system and any satellite components contained therein to customize said integrated satellite system to operate within a satellite variant.

13. The method of claim 1, wherein prior to said encapsulating said method further comprises:
forming a cavity or pocket in said material matrix;
inserting a satellite component into said cavity;
bonding said satellite component to said material matrix;
potting said satellite component within said cavity, said step of encapsulating effectively embedding said potted satellite component.

14. A method for fabricating a highly integrated satellite system for use with a satellite using, at least in part, an additive manufacturing technique, said method comprising:
creating an integrated satellite system model from digital data;
providing a plurality of material layers having contact surfaces therebetween;
forming said integrated satellite system, as based on said integrated satellite system model, in accordance with an ultrasonic consolidation process by transmitting ultrasonic vibrations to one or more of said contact surfaces to cause said material layers to consolidate and bond directly to one another without melting said material layers in bulk; and
positioning one or more satellite components between said material layers for the purpose of embedding said satellite components within a material matrix formed during said ultrasonic consolidation process.

15. The method of claim 14, further comprising subjecting said integrated satellite system to a direct write process, wherein one or more material traces is automatically written on one or more surfaces of said integrated satellite system to provide said integrated satellite system with a pre-determined function, said material traces being based on corresponding indicia in said integrated satellite system model.

16. The method of claim 15, wherein said subjecting said integrated satellite system to a direct write process is done simultaneously with said forming said integrated satellite system and said positioning one or more satellite components.

17. The method of claim 14, further comprising selecting said material trace from the group consisting of a conductive trace, an insulative trace, a capacitive trace, a fluid communicating trace, an electrical signal communicating trace, a sensing trace, and any combination of these.

18. The method of claim 14, further comprising configuring said material trace to fabricate one of a device, object, and system selected from the group consisting of a conductor, an insulator, a capacitor, a battery, an antenna, a data distribution circuit, a power distribution circuit, an electrical network, a sensor, an actuator, and any combination of these.

19. The method of claim 14, further comprising reconfiguring said integrated satellite system and any satellite components contained therein to customize said integrated satellite system to operate within a satellite variant.

20. A method for fabricating an integrated satellite system for use within a satellite, said method comprising:
creating an integrated satellite system model from digital data;
initiating an ultrasonic consolidation process to create an integrated satellite system based on said integrated satellite system model;
embedding one or more satellite components within said integrated satellite system during said ultrasonic consolidation process; and
initiating a direct write process to automatically write a material trace on one or more surfaces of said integrated satellite system, said material trace being based on corresponding indicia in said integrated satellite system model.

21. The method of claim 20, further comprising selecting said material trace from the group consisting of a conductive trace, an insulative trace, a capacitive trace, a fluid communicating trace, an electrical signal communicating trace, a sensing trace, and any combination of these.

22. The method of claim 20, further comprising configuring said material trace to fabricate one of a device, object, and system selected from the group consisting of a conductor, an insulator, a capacitor, a battery, an antenna, a data distribution circuit, a power distribution circuit, an electrical network, a sensor, an actuator, and any combination of these.

23. The method of claim 20, further comprising reconfiguring said integrated satellite system and any satellite components contained therein to customize said integrated satellite system to operate within a satellite variant

24. A method for fabricating an integrated satellite system comprising:
providing a plurality of material layers having contact surfaces therebetween;
transmitting ultrasonic vibrations to one or more of said contact surfaces to cause said material layers to consolidate and bond directly to one another to form a material matrix without melting said material layers in bulk; and
configuring said material layers to form said integrated satellite system.

25. The method of claim 24, further comprising embedding one or more satellite components between said material layers to encapsulate said satellite components within said material matrix.

26. The method of claim 24, wherein said transmitting ultrasonic vibrations comprises forming and building an integral or internal satellite component within said material matrix of said integrated satellite system.

27. The method of claim 26, further comprising depositing a material trace directly onto a surface of said integral satellite component to provide a mesoscopic device configured to complete the formation of and/or to be operable with said integral satellite component.

28. A method for forming a mesoscopic device on an integrated satellite system, said method comprising:
fabricating an integrated satellite system having one or more satellite components supported therein; and
depositing a material trace directly to a surface of said integrated satellite system to provide a mesoscopic device, said material trace having a pre-determined arrangement configured to enable said mesoscopic device to perform a pre-determined function.

29. The method of claim 28, further comprising encapsulating said material traces within a material matrix using an additive manufacturing technique.

30. The method of claim 28, wherein said applying comprising initiating a direct write process, wherein a dispensing device is used to apply said material trace to said surface.

31. The method of claim 28, further comprising creating an integrated satellite system model of said integrated satellite system and said material trace to be deposited thereon, said depositing forming said arrangement of said material trace based on said integrated satellite system model and any parameters associated therewith.

32. The method of claim 28, further comprising configuring said material trace to form an electrical connector.

33. The method of claim 28, further comprising selecting said material trace from the group consisting of a conductive trace, an insulative trace, a capacitive trace, a fluid communicating trace, an electrical signal communicating trace, a sensing trace, and any combination of these.

34. The method of claim 28, further comprising configuring said material trace to fabricate one of a device, an object, and a system selected from the group consisting of a conductor, an insulator, a capacitor, a battery, an antenna, a data distribution circuit, a power distribution circuit, an electrical network, a sensor, an actuator, and any combination of these.

35. A satellite comprising:
an integrated satellite system being formed of a material matrix, and operatively related to at least one other integrated satellite system to perform a pre-determined function;
a satellite component encapsulated within said material matrix of said integrated satellite system, said satellite component also being configured to perform a pre-determined function; and
a material trace deposited onto one or more surfaces of said integrated satellite system to provide a mesoscopic device configured to perform a pre-determined function.

36. The satellite of claim 35, wherein material trace is operatively connected to a satellite component.

37. The satellite of claim 35, wherein said material trace is encapsulated within said material matrix of said integrated satellite system.

38. The satellite of claim 35, further comprising a plurality of integrated satellite systems, satellite components, and material traces configured to operatively interact with one another to form a satellite variant.

39. The satellite of claim 35, wherein said integrated satellite system comprises a satellite panel selected from the group consisting of communications panels, power management panels, processor panels, solar array gimbal panels, attitude control panels, and any combination of these.

40. The satellite of claim 35, wherein said integrated satellite system comprises a satellite module selected from the group consisting of communications modules, power management modules, processor modules, solar array gimbal modules, attitude control modules, propulsion modules, thruster group modules, launch interface modules, frame modules, and payload interface modules, and any combination of these.

41. The satellite of claim 35, wherein said satellite components are selected from the group consisting of structural reinforcements, fiber optics, heat pipes, trace elements, actuators, sensors, antennas, connectors, wiring, and any combination of these.
